(19) United States
(12) Patent Application Publication
(10) Pub. No.: US 2023/0395786 A1
(43) Pub. Date: Dec. 7, 2023

(54) ANODELESS ALL-SOLID-STATE BATTERY

(71) Applicants: HYUNDAI MOTOR COMPANY, Seoul (KR); KIA CORPORATION, Seoul (KR)

(72) Inventors: Hee Soo Kang, Seoul (KR); Young Jin Nam, Suwon-si (KR); Sang Wan Kim, Anyang-si (KR); Seon Hwa Kim, Cheongju-si (KR); Jae Min Lim, Suwon-si (KR); Hong Suk Choi, Hwaseong-si (KR)

(73) Assignees: Hyundai Motor Company, Seoul (KR); Kia Corporation, Seoul (KR)

(21) Appl. No.: 17/994,942

(22) Filed: Nov. 28, 2022

(30) Foreign Application Priority Data
Jun. 3, 2022 (KR) 10-2022-0068067

(51) Int. Cl. H01M 4/36; H01M 4/131; H01M 4/134

(52) U.S. Cl. CPC H01M 4/366; H01M 4/131; H01M 4/134

(57) ABSTRACT

An all-solid-state battery includes an anode current collector, an intermediate layer located on the anode current collector, a solid electrolyte layer located on the intermediate layer, a cathode active material layer located on the solid electrolyte layer and including a cathode active material, and a cathode current collector located on the cathode active material layer, wherein the intermediate layer includes a metal configured to form an alloy with lithium, and satisfies Equation 1 below,

50≤Metal Content in Intermediate Layer/Discharge Capacity Density [μg/mAh]≤200 [Equation 1].

### CROSS-REFERENCE TO RELATED APPLICATION

This application claims under 35 U.S.C. § 119(a) the benefit of priority to Korean Patent Application No. 10-2022-0068067 filed on Jun. 3, 2022 in the Korean Intellectual Property Office, the entire contents of which are incorporated herein by reference.

### TECHNICAL FIELD

The present disclosure relates to an anodeless all-solid-state battery having an intermediate layer including a metal capable of alloying with lithium.

### BACKGROUND

An all-solid-state battery is a three-layer stack including a cathode active material layer disposed on a cathode current collector, an anode active material layer disposed on an anode current collector, and a solid electrolyte layer interposed between the cathode active material layer and the anode active material layer.

In general, the anode active material layer includes a solid electrolyte conducting lithium ions and an anode active material, such as graphite. The solid electrolyte has a greater specific gravity than a liquid electrolyte, and thus, the energy density of the all-solid-state battery is lower than that of a lithium ion battery using a liquid electrolyte.

In order to solve the above problem, i.e., to increase the energy density of the all-solid-state battery, research on application of lithium metal as an anode is underway. However, there are many obstacles to overcome, including research technical problems, such as interfacial bonding, growth of lithium dendrites, etc., and industrial technical problems, such as costs, a difficulty in securing a large-scale, etc.

Recently, research on an anodeless all-solid-state battery in which an anode is omitted and lithium ions (Li⁺) is directly precipitated in the form of lithium metal on an anode current collector is ongoing.

The anodeless all-solid-state battery has an intermediate layer, which includes silver (Ag) and a carbon material, and is interposed between a solid electrolyte layer and the anode current collector, so as to uniformly precipitate and deposit lithium. When the all-solid-state battery is charged, lithium ions (Li⁺) from a cathode reach the intermediate layer through the solid electrolyte layer. The lithium ions (Li⁺) migrate while alloying with silver (Ag), and is then precipitated in the form of lithium metal between the anode current collector and the intermediate layer after migration.

The theoretical specific capacity of the anode active material, such as graphite, configured to store lithium in the conventional lithium ion battery is well known, but the anodeless all-solid-state battery has no element configured to accommodate lithium ions.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide an indicator to predict a proper amount of a metal in an intermediate layer and cell performance depending on the capacity of a cathode.

In one aspect, the present disclosure provides an all-solid-state battery including an anode current collector, an intermediate layer disposed on the anode current collector, a solid electrolyte layer disposed on the intermediate layer, a cathode active material layer disposed on the solid electrolyte layer and including a cathode active material, and a cathode current collector disposed on the cathode active material layer, wherein the intermediate layer may include a metal capable of alloying with lithium, and satisfies Equation 1 below,

50≤Content of Metal in Intermediate Layer/Discharge Capacity Density [μg/mAh]≤200. [Equation 1]

In a preferred embodiment, the cathode active material may include Li[NiₓCo_{(1-x)/2}Mn₍₁₋ₓ₎₂]O₂ (x≥0.6).

In another preferred embodiment, a capacity of the cathode active material may be about 160 mAh/g to 185 mAh/g.

In still another preferred embodiment, the metal may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

In yet another preferred embodiment, the content of metal in the intermediate layer may be about 180 μg/cm² to 500 μg/cm².

In still yet another preferred embodiment, the discharge capacity density may be about 2.0 mAh/cm² to 3.0 mAh/cm².

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a cross-sectional view of an all-solid-state battery according to the present disclosure;

FIG. 2 shows a cross-sectional view of the state in which the all-solid-state battery shown in FIG. 1 is charged;

FIG. 3 shows voltage profiles of all-solid-state batteries according to Example 2, Comparative Example 1 and Comparative Example 2 in the first charge-discharge cycle;

FIG. 4 shows charge and discharge efficiencies of the all-solid-state batteries according to Example 2, Comparative Example 1 and Comparative Example 2;

FIG. 5 shows capacity retentions of the all-solid-state batteries according to Example 2, Comparative Example 1 and Comparative Example 2;

FIG. 6 shows voltage profiles of all-solid-state batteries according to Example Comparative Example 3 and Comparative Example 4 in the first charge-discharge cycle;

FIG. 7 shows capacity retentions of the all-solid-state batteries according to Example 5, Comparative Example 3 and Comparative Example 4;

FIG. 8 shows profiles of all-solid-state batteries according to Example 7 and Comparative Example 5 in the first charge-discharge cycle;

FIG. 9 shows charge and discharge efficiencies of the all-solid-state batteries according to Example 7 and Comparative Example 5; and

FIG. 10 shows capacity retentions of the all-solid-state batteries according to Example 7 and Comparative Example 5.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8, 7, 6, 5, 4, 3, 2, 1 percent above or below the numerical value (except where such number would exceed 100% of a possible value or go below 0%) or a plus/minus manufacturing/measurement tolerance of the numerical value. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

FIG. 1 shows a cross-sectional view of an all-solid-state battery according to the present disclosure.

The all-solid-state battery may include an anode current collector 10, an intermediate layer 20 disposed on the anode current collector 10, a solid electrolyte layer 30 disposed on the intermediate layer 20, a cathode active material layer 40 disposed on the solid electrolyte layer 30, and a cathode current collector 50 disposed on the cathode active material layer 40.

The anode current collector 10 may be a plate-shaped base material having electrical conductivity. The anode current collector 10 may be provided in the form of a sheet, a thin film or a foil.

The anode current collector 10 may include a material which does not react with lithium. The anode current collector 10 may include at least one selected from the group consisting of nickel (Ni), copper (Cu), stainless steel (SUS) and combinations thereof.

The intermediate layer 20 may include a metal capable of alloying with lithium.

The metal may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

The intermediate layer 20 may further include a carbon material. The carbon material may include amorphous carbon.

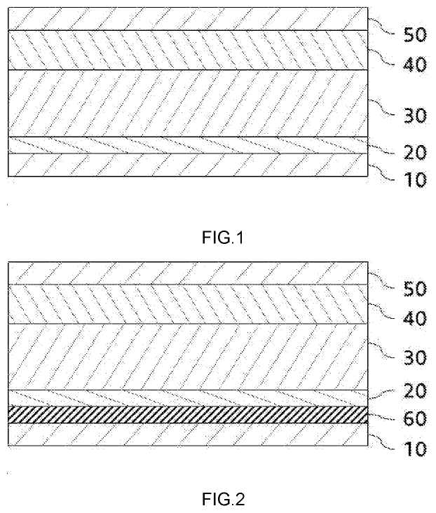

FIG. 2 shows a cross-sectional view of the state in which the all-solid-state battery shown in FIG. 1 is charged. The all-solid-state battery may include a lithium layer 60 interposed between the anode current collector 10 and the intermediate layer 20.

At the initial stage of charging of the all-solid-state battery, lithium ions may migrate to the intermediate layer 20 through the solid electrolyte layer 30. The lithium ions may migrate to the anode current collector 10 through the nitride of the metal M, and react with the metal M during such a process, thus forming a M-Li alloy between the anode current collector 10 and the intermediate layer 20. When the all-solid-state battery continues to be charged, lithium is uniformly deposited or precipitated around the M-Li alloy, thereby forming the lithium layer 60. The lithium layer 60 may include at least lithium metal.

The intermediate layer 20 may satisfy Equation 1 below.

50≤Content of Metal in Intermediate Layer/Discharge Capacity Density [μg/mAh]≤200 [Equation 1]

The content of the metal in the intermediate layer 20 may indicate the content of the metal per unit area [cm²] of the intermediate layer 20. The content of the metal in the intermediate layer 20 may be about 180 μg/cm² to 500 μg/cm².

The discharge capacity density may indicate the capacity [mAh] of a cathode active material per unit area [cm²]. The discharge capacity density may be about 2.0 mAh/cm² to 3.0 mAh/cm². The discharge capacity density may be adjusted through the loading amount of the cathode active material per unit area, the content of a cathode active material included in the cathode active material layer 40, the capacity of the cathode active material, etc.

Equation 1 above may indicate the amount of the metal used compared to the available capacity of the cathode active material. The available capacity of the cathode active material may mean an absolute capacity of lithium coming from the cathode active material layer 40 which may charge an anode. When the all-solid-state battery is charged, some of lithium ions deintercalated from the cathode active material layer 40 may be alloyed with the metal M in the intermediate layer 20, and the remaining lithium ions are precipitated in the form of lithium metal between the anode current collector 10 and the intermediate layer 20. The amount of the metal indicates the amount of metal M which is alloyed with lithium in the intermediate layer 20. The intermediate layer 20 satisfy Equation 1 above, an all-solid-state battery having excellent charge and discharge efficiency and durability may be acquired.

The solid electrolyte layer 30 may be interposed between the cathode active layer 40 and the anode current collector 10, and conduct lithium ions.

The solid electrolyte layer 30 may include a solid electrolyte having lithium ion conductivity.

The solid electrolyte may include at least one selected from the group consisting of oxide-based solid electrolytes, sulfide-based solid electrolytes, polymer solid electrolytes and combinations thereof. Preferably, a sulfide-based solid electrolyte having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), and Li₁₀GeP₂S₁₂, without being limited thereto.

The oxide-based solid electrolytes may include perovskite-type LLTO (Li₃ₓLa_{2/3-x}TiO₃), phosphate-based NASICON-type LATP(Li₁₊ₓAlₓTi₂₋ₓ(PO₄)₃), etc. The polymer electrolytes may include gel polymer electrolytes, solid polymer electrolytes, etc.

The cathode active material layer 40 may intercalate and deintercalate lithium ions. The cathode active material layer 40 may include a cathode active material, a solid electrolyte, a conductive material, a binder, etc.

The cathode active material may include Li[NiₓCo_{(1-x)/2}Mn₍₁₋ₓ₎₂]O₂ (1>x≥0.6). Concretely, the cathode active material may include at least one selected from the group consisting of Li[Ni_{0.7}Co_{0.15}Mn_{0.15}]O₂, Li[Ni_{0.75}Co_{0.125}Mn_{0.125}]O₂, Li[Ni_{0.8}Co_{0.1}Mn_{0.1}]O₂ and combinations thereof.

The capacity of the cathode active material may be about 160 mAh/g to 185 mAh/g.

The solid electrolyte may include at least one selected from the group consisting of oxide-based solid electrolytes, sulfide-based solid electrolytes, polymer solid electrolytes and combinations thereof. Preferably, a sulfide-based solid electrolyte having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂-B₂S₃-LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), and Li₁₀GeP₂S₁₂, without being limited thereto.

The oxide-based solid electrolytes may include perovskite-type LLTO (Li₃ₓLa_{2/3-x}TiO₃), phosphate-based NASICON-type LATP(Li₁₊ₓAlₓTi₂₋ₓ(PO₄)₃), etc.

The polymer electrolytes may include gel polymer electrolytes, solid polymer electrolytes, etc.

The conductive material may include carbon black, conductive graphite, ethylene black, graphene or the like.

The binder may be the same as a binder included in the intermediate layer 20, and may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC) or the like, without being limited thereto.

The cathode current collector 50 may be a plate-shaped base material having electrical conductivity. The cathode current collector 50 may be provided in the form of a sheet or a thin film.

The cathode current collector 50 may include at least one selected from the group consisting of indium (In), copper (Cu), magnesium (Mg), aluminum (Al), stainless steel, iron (Fe) and combinations thereof.

Hereinafter, the present disclosure will be described in more detail through the following examples. The following examples serve merely to exemplarily describe the present disclosure, and are not intended to limit the scope of the disclosure.

### Example 1 to Example 3, Comparative Example 1 and Comparative Example 2

All-solid-state batteries having the structure shown in FIG. 1 were manufactured.

Li[Ni_{0.7}Co_{0.15}Mn_{0.15}]O₂ (NCM711) was used as a cathode active material. The loading amount of the cathode active material was about 20 mg/cm², the content of the cathode active material in a cathode active material layer was about 76.7%, and the capacity of the cathode active material was about 160 mAh/g.

An intermediate layer was prepared by mixing silver (Ag) and amorphous carbon.

The detailed specifications of the respective all-solid-state batteries are set forth in Table 1 below.

TABLE 1

| | Comp. | | | | Comp. |
|---|---|---|---|---|---|
| Category | Example 1 | Example 1 | Example 2 | Example 3 | Example 2 |
| Loading | 2.151 | 1.822 | 0.838 | 0.778 | 0.439 |
| amount of | | | | | |
| intermediate | | | | | |
| layer | | | | | |
| [mg/cm²] | | | | | |
| Metal | 0.538 | 0.455 | 0.209 | 0.194 | 0.110 |
| content (a) | | | | | |
| [μg/cm²] | | | | | |
| Discharge | 2.454 | 2.454 | 2.454 | 2.454 | 2.454 |
| capacity | | | | | |
| density (b) | | | | | |
| [mAh/cm²] | | | | | |
| (a)/(b) | 219.066 | 185.544 | 85.306 | 79.205 | 44.736 |
| [μg/mAh] | | | | | |
| Cell | Poor | Good | Good | Good | Poor |
| performance | | | | | |

The above cell performances of the respective all-solid-state batteries were evaluated depending on the following criteria.
It is determined that cell performance of an all-solid-state battery is good when the initial discharge capacity of the all-solid-state battery is equal to or greater than about 95% of a reference capacity in an initial voltage profile. It is determined that cell performance of an all-solid-state battery is poor when the initial discharge capacity of the all-solid-state battery is less than 95% of the reference capacity.
It is determined that cell performance of an all-solid-state battery is good when the initial Coulombic efficiency of the all-solid-state battery is equal to or greater than 85%.
It is determined that cell performance of an all-solid-state battery is good when the durability property of the all-solid-state battery after 10 cycles is equal to or greater than 80%.

When an all-solid-state battery satisfied all of the above-described three requirements, it was determined that cell performance of the all-solid-state battery is good.

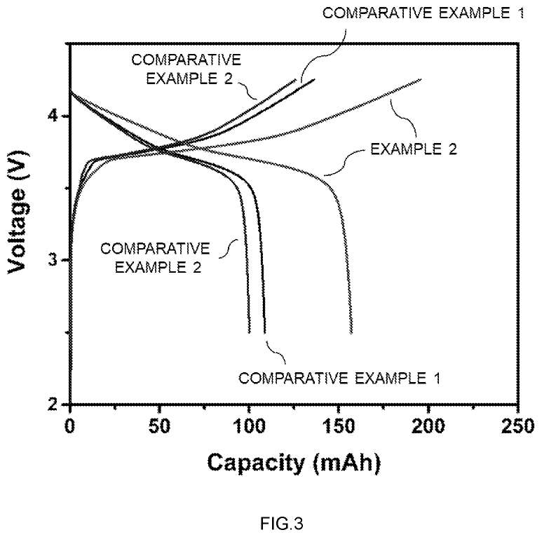

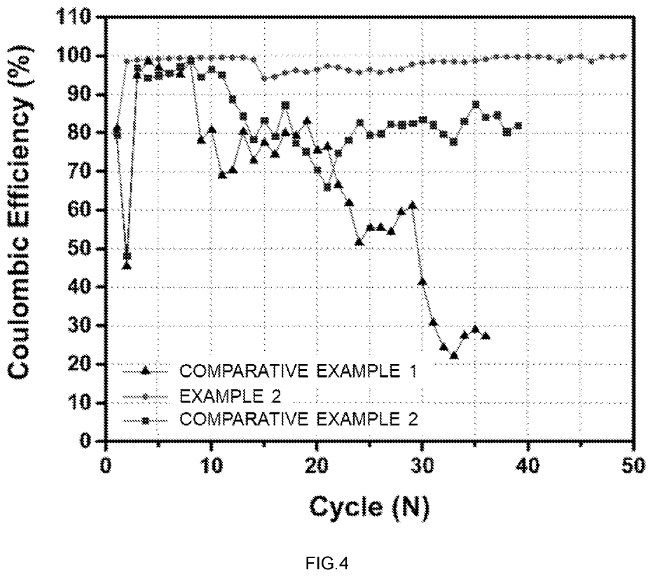

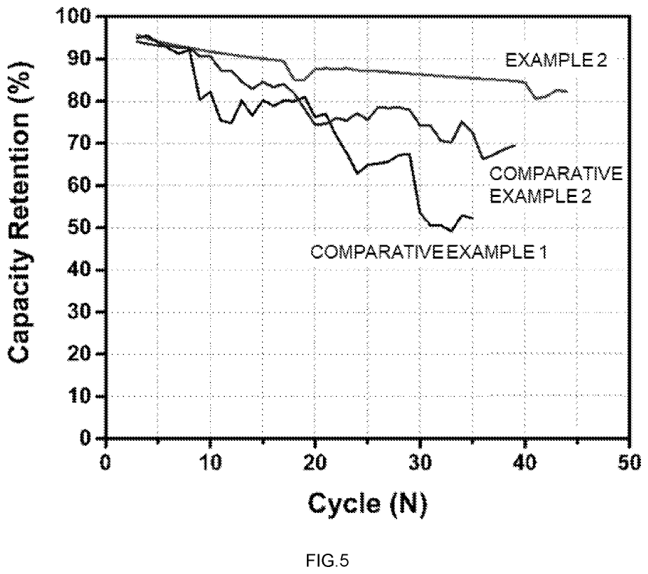

FIG. 3 shows voltage profiles of all-solid-state batteries according to Example 2, Comparative Example 1 and Comparative Example 2 in the first charge-discharge cycle. FIG. 4 shows charge and discharge efficiencies of the all-solid-state batteries according to Example 2, Comparative Example 1 and Comparative Example 2. FIG. shows capacity retentions of the all-solid-state batteries according to Example 2, Comparative Example 1 and Comparative Example 2. These results are set forth in Table 2 below.

TABLE 2

| | | Initial characteristics of cell | | | Results after 10 | |
|---|---|---|---|---|---|---|
| | | | | Charge and | charge-discharge cycles | |
| | | Charge | Discharge | discharge | Capacity | Coulombic |
| | (a)/(b) | capacity | capacity | efficiency | retention | efficiency |
| Category | [μg/mAh] | [mAh/g] | [mAh/g] | [%] | [%] | [%] |
| Comp. | 219.066 | 157.1 | 125.1 | 80.7 | 81.4 | 80.75 |
| Example 1 | | | | | | |
| Example 2 | 85.306 | 196.9 | 157.9 | 98.5 | 93.2 | 99.1 |
| Comp. | 44.736 | 153.76 | 121.8 | 79.5 | 90.0 | 96.4 |
| Example 2 | | | | | | |

Referring to FIGS. 3 to 5 and Table 2, the all-solid-state battery according to Example 2 has excellent charge and discharge efficiency, capacity retention and Coulombic efficiency compared to the all-solid-state batteries according to Comparative Example 1 and Comparative Example 2.

### Example 4 to Example 6, Comparative Example 3 and Comparative Example 4

All-solid-state batteries having the structure shown in FIG. 1 were manufactured.

Li[Ni_{0.75}Co_{0.125}Mn_{0.125}]O₂ (Ni 75%) was used as a cathode active material. The loading amount of the cathode active material was about 23.23 mg/cm², the content of the cathode active material in a cathode active material layer was about 80%, and the capacity of the cathode active material was about 150 mAh/g.

An intermediate layer was prepared by mixing silver (Ag) and amorphous carbon.

The detailed specifications of the respective all-solid-state batteries are set forth in Table 3 below.

TABLE 3

| | Comp. | | | | Comp. |
|---|---|---|---|---|---|
| Category | Example 3 | Example 4 | Example 5 | Example 6 | Example 4 |
| Loading | 2.482 | 1.852 | 0.952 | 0.756 | 0.421 |
| amount of | | | | | |
| intermediate | | | | | |
| layer | | | | | |
| [mg/cm²] | | | | | |
| Metal | 0.621 | 0.463 | 0.238 | 0.189 | 0.105 |
| content (a) | | | | | |
| [μg/cm²] | | | | | |
| Discharge | 2.787 | 2.787 | 2.787 | 2.787 | 2.787 |
| capacity | | | | | |
| density (b) | | | | | |
| [mAh/cm²] | | | | | |
| (a)/(b) | 222.625 | 166.117 | 85.390 | 67.810 | 37.762 |
| [μg/mAh] | | | | | |
| Cell | Poor | Good | Good | Good | Poor |
| performance | | | | | |

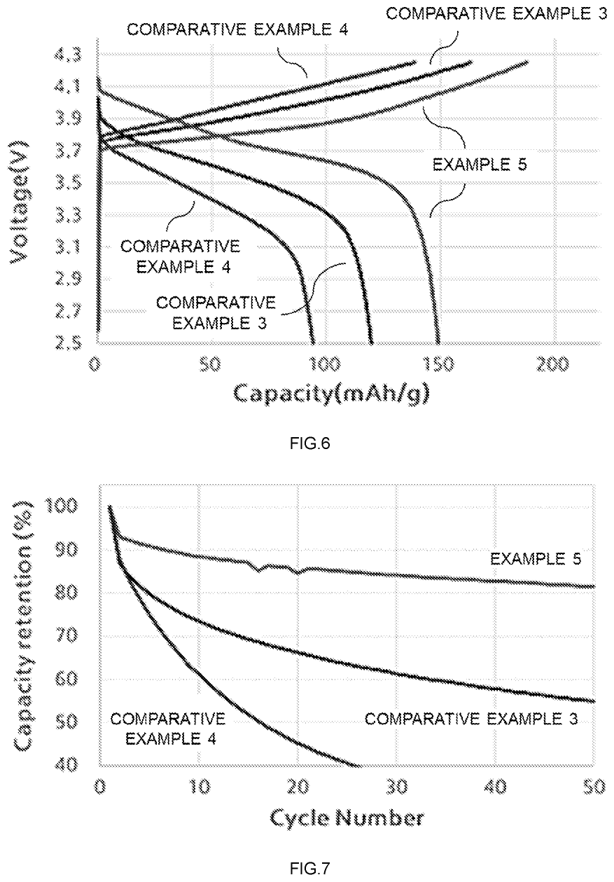

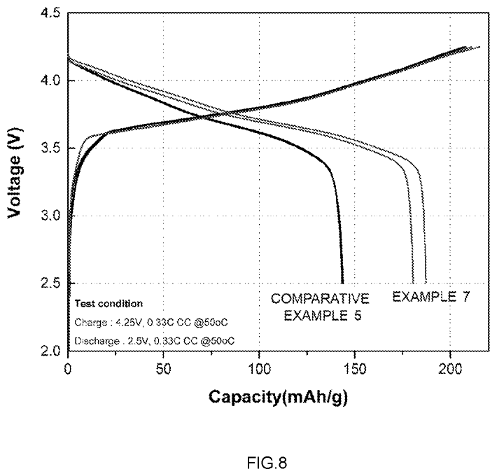

FIG. 6 shows voltage profiles of all-solid-state batteries according to Example Comparative Example 3 and Comparative Example 4 in the first charge-discharge cycle. FIG. 7 shows capacity retentions of the all-solid-state batteries according to Example 5, Comparative Example 3 and Comparative Example 4. These results are set forth in Table 4 below.

TABLE 4

| | | Initial characteristics of cell | | | Results after 10 | |
|---|---|---|---|---|---|---|
| | | | | Charge and | charge-discharge cycles | |
| | | Charge | Discharge | discharge | Capacity | Coulombic |
| | (a)/(b) | capacity | capacity | efficiency | retention | efficiency |
| Category | [μg/mAh] | [mAh/g] | [mAh/g] | [%] | [%] | [%] |
| Comp. | 222.625 | 167.9 | 121.3 | 79.7 | 75.8 | 81.78 |
| Example 3 | | | | | | |
| Example 5 | 83.39 | 187.2 | 150.2 | 97.5 | 89.1 | 98.2 |
| Comp. | 37.762 | 139.2 | 95.8 | 75.5 | 61.9 | 75.4 |
| Example 4 | | | | | | |

Referring to FIGS. 6 and 7 and Table 4, the all-solid-state battery according to Example 5 has excellent charge and discharge efficiency, capacity retention and Coulombic efficiency compared to the all-solid-state batteries according to Comparative Example 3 and Comparative Example 4.

### Example 7 and Comparative Example 5

All-solid-state batteries having the structure shown in FIG. 1 were manufactured.

Li[Ni_{0.8}Co_{0.1}Mn_{0.1}]O₂ (NCM811) was used as a cathode active material. The loading amount of the cathode active material was about 20 mg/cm², the content of the cathode active material in a cathode active material layer was about 80.0%, and the capacity of the cathode active material was about 185 mAh/g.

An intermediate layer was prepared by mixing silver (Ag) and amorphous carbon.

The detailed specifications of the respective all-solid-state batteries are set forth in Table 5 below.

TABLE 5

| Category | Comp. Example 5 | Example 7 |
|---|---|---|
| Loading amount of | 0.436 | 1.073 |
| intermediate layer | | |
| [mg/cm²] | | |
| Metal content (a) | 0.109 | 0.268 |
| [μg/cm²] | | |
| Discharge capacity | 2.960 | 2.960 |
| density (b) | | |
| [mAh/cm²] | | |
| (a)/(b) | 36.791 | 90.583 |
| [μg/mAh] | | |
| Cell performance | Poor | Good |

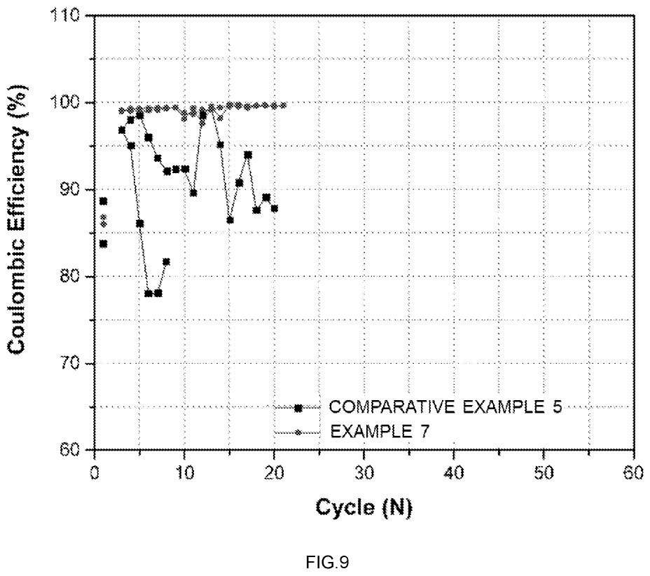

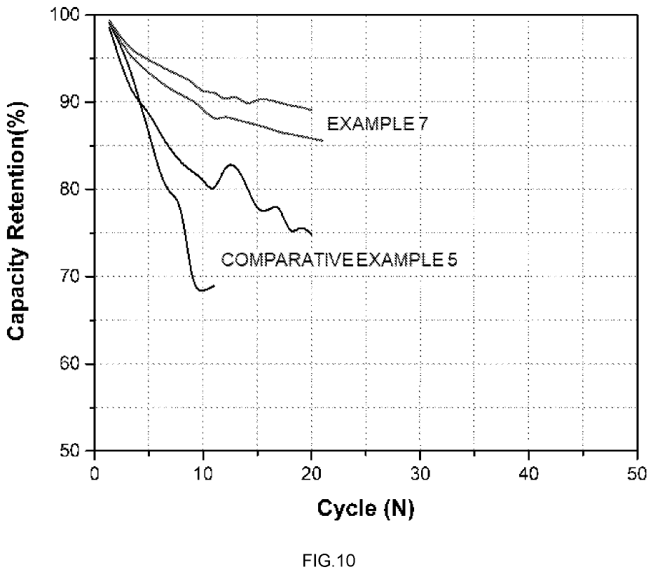

FIG. 8 shows voltage profiles of all-solid-state batteries according to Example 7 and Comparative Example 5 in the first charge-discharge cycle. FIG. 9 shows charge and discharge efficiencies of the all-solid-state batteries according to Example 7 and Comparative Example 5. FIG. 10 shows capacity retentions of the all-solid-state batteries according to Example 7 and Comparative Example 5. These results are set forth in Table 6 below.

TABLE 6

| | | Initial characteristics of cell | | | Results after 10 | |
|---|---|---|---|---|---|---|
| | | | | Charge and | charge-discharge cycles | |
| | | Charge | Discharge | discharge | Capacity | Coulombic |
| | (a)/(b) | capacity | capacity | efficiency | retention | efficiency |
| Category | [μg/mAh] | [mAh/g] | [mAh/g] | [%] | [%] | [%] |
| Comp. | 36.791 | 205.7 | 165.6 | 86.3 | 88.5 | 97.3 |
| Example 5 | | | | | | |
| Example 7 | 90.583 | 213.1 | 183.7 | 86.2 | 81.2 | 91.3 |

Referring to FIGS. 8 to 10 and Table 6, the all-solid-state battery according to Example 7 has excellent charge and discharge efficiency, capacity retention and Coulombic efficiency compared to the all-solid-state battery according to Comparative Example 5.

As is apparent from the above description, in an anodeless all-solid-state battery according to the preset disclosure, a proper amount of a metal in an intermediate layer and cell performance may be predicted depending on the capacity of a cathode. Therefore, an anodeless all-solid-state battery may flexibly cope with change in the specifications of a cathode active material, such as the kind of the cathode active material.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An all-solid-state battery, comprising:
an anode current collector;
an intermediate layer disposed on the anode current collector;
a solid electrolyte layer disposed on the intermediate layer;
a cathode active material layer disposed on the solid electrolyte layer and comprising a cathode active material; and
a cathode current collector disposed on the cathode active material layer,
wherein the intermediate layer comprises a metal capable of alloying with lithium, and satisfies Equation 1 below,
50≤Content of Metal in Intermediate Layer/Discharge Capacity Density [μg/mAh]≤200. [Equation 1]

2. The all-solid-state battery of claim 1, wherein the cathode active material comprises Li[NiₓCo_{(1-x)/2}Mn₍₁₋ₓ₎₂]O₂ (x≥0.6).

3. The all-solid-state battery of claim 1, wherein a capacity of the cathode active material is about 160 mAh/g to 185 mAh/g.

4. The all-solid-state battery of claim 1, wherein the metal comprises at least one of gold (Au), platinum (Pt), palladium (Pd), silicon (Si), silver (Ag), aluminum (Al), bismuth (Bi), tin (Sn), zinc (Zn) or any combination thereof.

5. The all-solid-state battery of claim 1, wherein the content of metal in the intermediate layer is about 180 μg/cm² to 500 μg/cm².

6. The all-solid-state battery of claim 1, wherein the discharge capacity density is about 2.0 mAh/cm² to 3.0 mAh/cm².
